(19) United States
(12) Patent Application Publication
(10) Pub. No.: US 2003/0149750 A1
(43) Pub. Date: Aug. 7, 2003

(54) Distributed storage array

(76) Inventor: Alan M. Franzenburg, Modesto, CA (US)

Correspondence Address: HEWLETT-PACKARD COMPANY, Intellectual Property Administration, P.O. Box 272400, Fort Collins, CO, 80527-2400, US

(21) Appl. No.: 10/071,406

(22) Filed: Feb. 7, 2002

(51) Int. Cl. G06F 15/177; G06F 15/16; G06F 17/30

(52) U.S. Cl. 709/220; 709/203; 707/10

(57) ABSTRACT

A device for storing distributed data in a networked storage array. The device includes a mass storage controller associated with a network. A mass storage device is included that is controlled by the mass storage controller. The mass storage device includes a portion of the distributed data. Client systems are included that have a mass storage, and each store a portion of the distributed data as directed by the mass storage controller. The distributed data is stored in a distributed storage file of the client system's mass storage. The client systems' mass storage is used primarily for the client system's data.

### BACKGROUND OF THE INVENTION

1. Field of the Invention

The present invention relates generally to storage arrays. More particularly, the present invention relates to distributed mass storage arrays.

2. Related Art

A computer network or server that does not provide redundancy or backup as part of its storage system will not be very reliable. If there is no backup or redundant system and the primary storage system fails, then the overall system becomes unusable. One method of providing a redundant storage system for use in a server and particularly a network server is to provide a standby server that can take over the services of the primary server in the event of a failure.

Another widely used backup system is the use of a disk array. One of the more prevalent forms of a disk array is a RAID or a Redundant Array of Independent Disks. A RAID array is a storage configuration that includes a number of mass storage units or hard drives. These independent hard drives can be grouped together with a specialized hardware controller. The specialized controller and hard drives are physically connected together and typically mounted into the server hardware. For example, a server can contain a RAID array card on its motherboard and there may be a SCSI connection between the controller and the hard drives.

A RAID array safeguards data and provides fast access to the data. If a disk fails, the data can often be reconstructed or a backup of the data can be used. RAID can be configured with six basic arrangements known as RAID 0-6 and there are extended configurations that expand the architecture. The data in a RAID system is organized in “stripes” of data across several disks. Striping divides the data into parts that are written in parallel to several hard disks. An extra disk can be used to store parity information, and the parity information is used to reconstruct data when a failure occurs. This architecture increases the chances that system users can access the data they need at any time.

One advantage of using a RAID array is that the access time to the RAID array is usually faster than retrieving data from a single drive. This is because one drive is able to deliver a portion of the distributed data while the other disk drives are delivering their respective portion of the data. Striping the data speeds storage access because multiple blocks of data can be read at the same time and then reassembled to form the original data.

A side effect of using a RAID array is that the mean time between failure (MTBF) of the array components is worse than if a single drive were involved. For example, if a RAID subsystem includes four drives and one controller, each with a MTBF of five years, one component on the subsystem will fail every year on average. Fortunately, the data on the RAID subsystem is redundant, and it takes just a few minutes to replace a drive and then the system can rebuild itself. The failed disk drive can also be removed from the array and then the array can continue without that disk for a period.

Some of the more important RAID configurations will now be discussed to aid in an understanding of redundant storage subsystems. RAID 0 is a disk array without parity or redundancy that distributes and accesses data across all the drives in the array. This means that the first data block is written to and read from the first drive, the second data block is written to the second drive and so on. Data distribution enhances the performance of the system but data replication or verification does not take place in RAID and so the removal or failure of one drive results in the loss of data.

RAID 1 provides redundancy by writing a copy of the data to a dedicated mirrored disk. This provides 100% redundancy but the read transfer rate is the same as a single disk. A RAID 2 system provides error correction with a Hamming code for each data stripe that is written to the data storage disks. RAID levels 1 and 2 have a number of disadvantages that will not be discussed here but which are overcome by RAID 3.

RAID 3 is a striped parallel array where data is distributed by bit, byte, sector or data block. One drive in the array provides data protection by storing a parity check byte for each data stripe. The disks are accessed simultaneously but the parity check is introduced for fault tolerance. The data is read/written across the drives one byte or sector at a time and the parity bit is calculated and either compared with the parity drive in a read operation or written to the parity drive in a write operation. This provides operational functionality even when there is a failed drive. If a drive fails then data can continue to be written to or read from the other data drives, and the parity bit allows the “missing” data to be reconstructed. When the failed drive is replaced, it can be reconstructed while the system is online.

RAID 5 combines the throughput of block interleaved data striping of RAID 0 with the parity reconstruction mechanism of RAID 3 without requiring an extra parity drive. This level of fault-tolerance incorporates the parity checksum at the sector level along with the data and checksum striping across drives instead of using a dedicated parity drive.

The RAID 5 technique allows multiple concurrent read/write operations for improved data throughput while maintaining data integrity. A single drive in the array is accessed when either data or parity information is being read from or written to that specific drive.

### SUMMARY

The invention provides a device and method for storing distributed data in a networked storage array. The device includes a mass storage controller associated with a network. A mass storage device is included that is controlled by the mass storage controller. The mass storage device includes a portion of the distributed data. Client systems are included that have a mass storage and each store a portion of the distributed data as directed by the mass storage controller. The distributed data is stored in a distributed storage file on the client system's mass storage. The client systems' mass storage is used primarily for the client system's data.

### BRIEF DESCRIPTION OF THE DRAWINGS

FIG. 1 is a block diagram illustrating a system for using mass storage located in a client system to store a portion of data from a storage array;

FIG. 2 is a block diagram of a system for creating a common operating environment from an image stored on a distributed storage array;

FIG. 3 illustrates a system for using mass storage located in a client to store mirrored data for a storage array;

FIG. 4 is a block diagram of a system for using mass storage located in a client to store parity checking for a storage array;

FIG. 5 illustrates a system for writing data to a client's mass storage while it is also being written to a RAID array.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

When RAID arrays were originally conceived, the idea was to use a number of inexpensive disks. Over time though, more expensive disks have been used in order to increase performance and the cumulative cost of creating a RAID array with seven, nine or even more disks can be relatively expensive. At the same time, many of the client computer systems that are attached to computer networks have excess storage located within the client system. Some client systems may use just 5-10% of the mass storage capacity (e.g., hard drive space) that is available on the systems. The network as a whole contains a significant amount of unused storage space but it is available only to the user of the client system who does not generally need all of the available local mass storage space. In addition, this local storage space is not very accessible from a centralized network point of view.

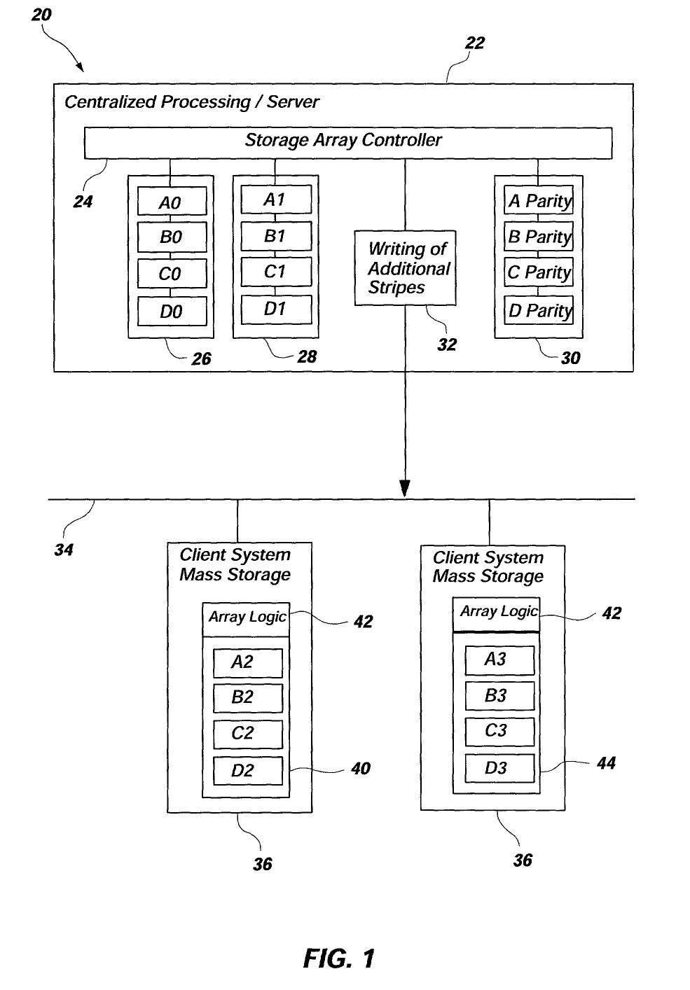

FIG. 1 illustrates a distributed network storage system 20 that is able to utilize unused client system storage space that is attached to the network. A centralized processing module 22 contains a storage array controller 24 or a distributed storage controller. The centralized processing module can also be a network server within which the storage array controller is mounted. The storage array controller or distributed storage controller is able to communicate with other processing systems through the network 34. The storage array controller is able to communicate with the network either through the server within which it is mounted or through a separate communication means associated with the storage array controller. The storage array controller includes one or more mass storage devices 26, 28, 30 that are linked to and directed by the storage array controller.

A plurality of client systems that have mass storage units 36 are also connected to the network 34. A client system is generally defined as a processing unit or computer that is in communication with a network server or centralized processing and storage system through a network. A distributed storage file 40, 44 is provided within the client system's mass storage in order to store a portion of the distributed data in the array. In the prior art, client systems and their associated mass storage have been used primarily for storing client system data. For example, most client systems include a local operating system, local applications and local data that are stored on the hard drive, Flash RAM, optical drive, or specific mass storage system of the client system. A client system can be a desktop computer, PDA, thin client, wireless device, or any other client processing device that has a substantial amount of mass storage.

The storage array controller 24 directs the distribution and storage of the data throughout the storage array system, and the client systems 36 communicate with the storage array controller through an array logic module 42. In the past, data in a storage array has been stored on a RAID array or similar storage where the storage disks are locally connected to the array controller. In contrast, the present embodiment allows data to be distributed across multiple client systems, in addition to any storage that is local to the controller.

The mass storage devices each store a portion of the array's distributed data, which is spread throughout the array. This is illustrated in FIG. 1 by the data stripes or blocks labeled with a letter and increasing numerical designations. For example, one logically related data group is distributed across multiple mass storage devices as A0, A1, A2 and A3.

In a manner similar to a RAID array, the data can be divided into “stripes” by the storage array controller 24. This means that a byte, sector or block of data from information sent to the storage array can be divided and then distributed between the separate disks. FIG. 1 further illustrates that two disks which are local to the storage array 26, 28 contain the first two stripes or sectors of a data write (A0 and A1) and then the additional stripes of the data write 32 are written by the storage array controller through the network 34 to the client systems' mass storage 40, 44. The third and fourth stripes of the data bytes or blocks are written to the client systems' mass storage as A2 and A3.

The area of the client systems' mass storage 40, 44 where the distributed data will be stored is defined generally here as a distributed storage file or a swap file. This is not a storage file or swap file as defined in the common prior art use of the term. A prior art type of storage file stores information for the local operating system or a swap file stores data that will not currently fit into the operating system's memory. In this situation, the distributed storage file stores distributed data sent by the storage array controller.

The distributed storage file can be hidden from the user. This protects the file and prevents an end user from modifying or trying to access the distributed storage file or swap file. The distributed storage file may also be dynamically resized by the storage array controller based on the storage space available on the client system or the amount of data to be stored. As client systems are added to or removed from the network, the client systems are registered into the storage array controller. This allows the storage array controller to determine how large the distributed storage file on each client system should be. If some client systems do not have room on their mass storage, then they may not have any distributed storage file at all.

In an alternative embodiment, the system can allocate a partition that will store the distributed storage file. A partition for the distributed storage file or distributed data is different from a conventional partition. In prior art terminology, a partition is a logical division of a mass storage device such as a hard drive that has been divided into fixed sections or partitions. These logical portions are available to the operating system and allow the end user to organize and store their data. In this situation, the partition or reserved part of the mass storage is allocated exclusively to the storage array controller. This means that even if the client is allowed to see this partition, they will be unable to modify or access the partition while the storage array controller is active. This partition can be dynamically resized as necessary based on the amount of information to be stored by the storage array.

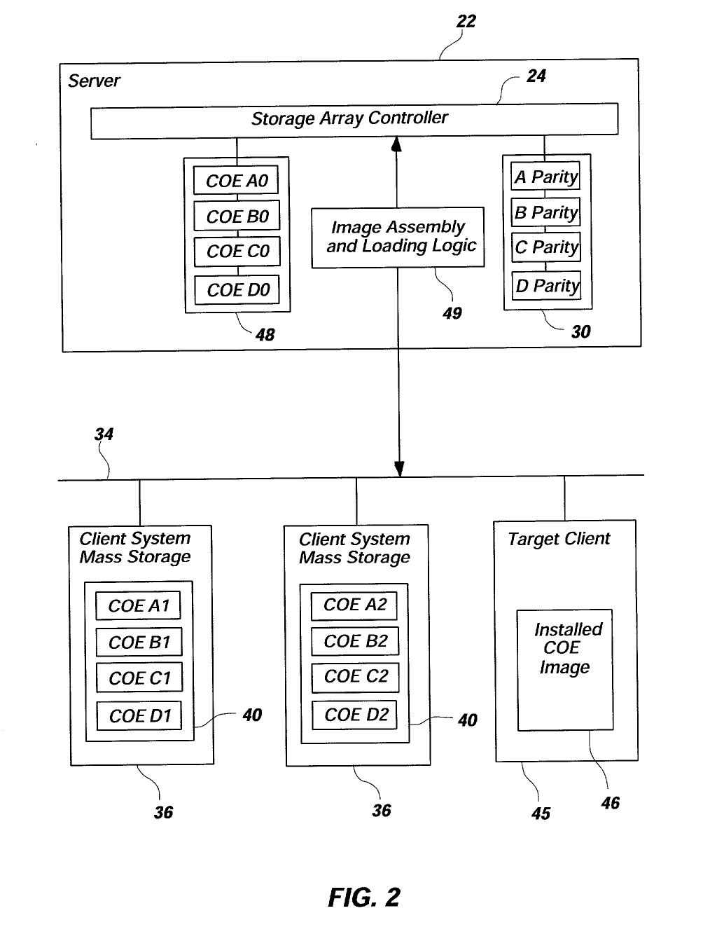

Another problem in the computer industry today is that Information Technology (IT) departments are currently limited in their ability to provide desktop support to large organizations. There have been vast improvements over the years in the areas of backup and restoring of data, network boot drives, and remote system management. Unfortunately, it still takes a significant amount of time to complete the initial setup and configuration of a client computer system for new employees and to perform damage control for crashed or corrupted systems. In the embodiment of the invention illustrated in FIG. 2, a distributed storage system can create a base client system image that is used in the installation and configuration of multiple client computers. This base image can be described as a common operating environment (COE) and it includes the operating system, drivers, and applications used by the client system. This system takes advantage of larger organizations with multiple client systems (e.g., desktop computers) and distributes a portion of the image across multiple client systems.

FIG. 2 is a block diagram of a system for creating a COE on a client system from an image stored on a distributed storage array. The figure illustrates an embodiment of the invention that utilizes a distributed storage array with distributed data on the client systems. A storage array controller 24 is associated with a server 22, and includes one or more local mass storage devices 48 such as a hard drive. In addition, client systems attached to the network 34 are also controlled by the storage array controller. Distributed data that is stored across the local mass storage devices and the client systems' mass storage devices is treated logically by the storage array controller as though it resides on a single physical unit. Thus, the COE image is striped across the local and client mass storage devices as illustrated by COE A0, COE A1, COE A2, etc.

The idea of using many client systems to store a part of the image can be described as redundant desktop generation. This is because it utilizes client computer systems on network segments for storage of the COE image or recovery logic. When a new employee arrives, setting up can be as easy as inserting a removable hard drive into the client system. The network specialist can then turn on the target client system 45 and enable the redundant desktop RAID logic (e.g., by running a program or script). The image assembly and loading logic 49 then assembles the image that is stored on multiple mass storage devices and fulfills the install requests. This allows the system to build a clean COE installation 46 from data that is distributed through the local network.

The redundant desktop can control baseline COE systems without the need of defining image storage on a storage array or purchasing extra equipment for that purpose. This is because the redundant desktop agent that controls the processing logic distributes the data image to the networked client systems. When more systems are present within the configured redundant desktop environment, this minimizes the load on individual client systems. Several system baseline configurations can be stored within the redundant desktop environment and the portions of the configuration that are needed from the redundant desktop will be loaded.

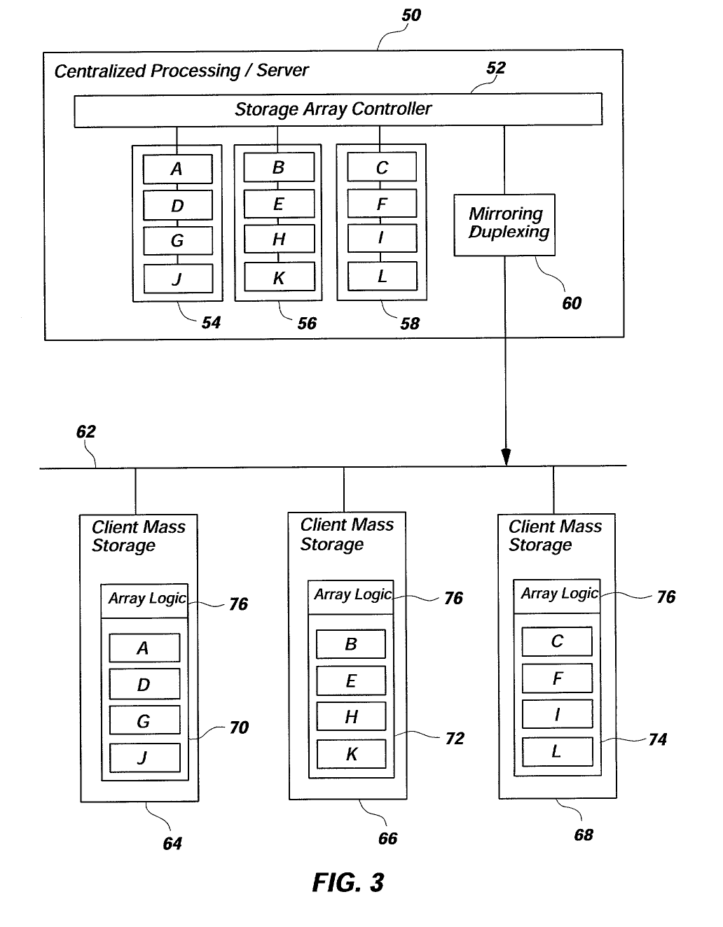

FIG. 3 illustrates a system for using mass storage located in a client system to store mirrored data in a distributed storage array. A storage array controller 52 can be located within a centralized processing module or a server 50. Alternatively, the storage array can be directly coupled to a network 62 and then the storage array controller may act as network-attached storage (NAS). Although, network-attached storage is physically separate from the server it can be mapped as a drive through the network directory system. In this embodiment, the storage array controller has a plurality of local mass storage devices 54, 56, 58 that are either directly attached to the storage array controller or located within the server and indirectly controlled by the storage array controller.

A group of client systems is connected to the network 62 and is accessible to the storage array controller 52. Each of these client systems includes mass storage 64, 66, 68. In many client systems, a portion of the client system's mass storage is unused because of the large size of the client system's mass storage in comparison to the amount of storage used by the client system. As mentioned, some client systems have 50-90% of their mass storage or hard disk that is available for use. The mass storage of the client is generally used for the code, data, and other local storage requirements of the client system and its local operating system (OS).

In order to leverage the client system's unused mass storage, this invention stores information on the otherwise empty mass storage of client systems. As described above, this is done by defining a file in the client mass storage device that is reserved for the storage array. In the embodiment of FIG. 3, the distributed storage files 70, 72, 74 are configured to store mirrored or duplexed data. The original copy of the data is stored in the local mass storage devices 54, 56, 58. This is shown by the notation letters A-L that represent the original data. As the original data is written by the storage array controller onto the local mass storage devices, the data is also mirrored or duplexed through a mirroring module 60 that writes the duplicated data to the mass storage of the client systems. The array logic 76 located in the client systems' mass storage receives the mirrored write requests and sends the writes to the appropriate distributed storage file located on the client systems.

When one of the local mass storage devices fails, this can create a number of failover situations. The first situation is where one of the local mass storage devices that is directly connected to the storage array controller fails and the storage disk or medium must be replaced. When the local mass storage device is replaced, then a replacement copy of that mass storage device or hard drive can be copied from the corresponding client system's redundant mass storage.

For example, if the hard drive 54 connected to the storage array controller fails, then the corresponding data can be copied from the client system's distributed storage file 70 and this can restore the storage array system. In another scenario when a mass storage device 54 fails, then the storage array controller uses the client system's distributed storage file as a direct replacement. The controller can access the client system's mass storage directly 70 to retrieve the appropriate information. This allows the storage array controller to deliver information to the network or network clients despite a storage system failure. Although direct access of the client system's mass storage will probably be slower than simply replacing the local mass storage device for the storage array controller, this provides a fast recovery in the event of hard drive crash or some other storage array component failure. Using the client system's mass storage devices with distributed storage files provides an inexpensive method to mirror a storage array without the necessity of purchasing additional expensive storage components (e.g., hard drives).

An alternative configuration for FIG. 3 is to distribute the mirroring over multiple client systems as opposed to a one-to-one mapping as illustrated in FIG. 3. For example, instead of writing every single block from a mass storage device 54 onto a specific client system's mass storage, the system can split one mirrored hard drive over multiple distributed storage files. Accordingly, the client's distributed storage file 70 (as in FIG. 3) can be distributed over multiple clients. This means the blocks illustrated as A, D, G and J would be spread across several client systems.

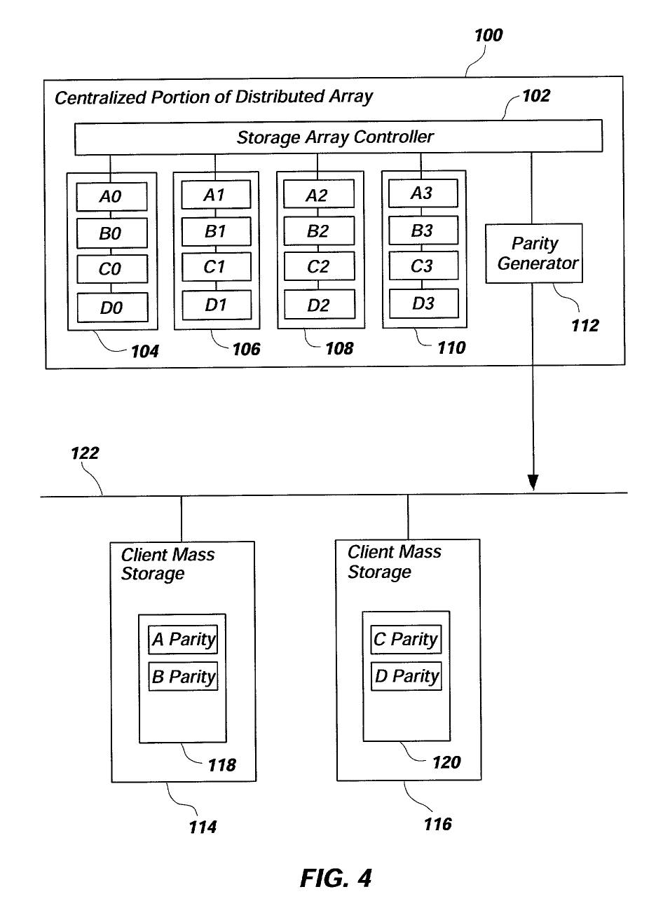

FIG. 4 is a block diagram illustrating a system for using a client system's mass storage to store parity data for a storage array. The centralized portion of a distributed array 100 is configured so that it is electronically accessible to client systems 114, 116 on the network 122. A storage array controller 102 is associated with the network or it is located within a network server. The storage array controller is connected to a number of local independent disks 104, 106, 108, 110 that store information sent to the storage array controller.

The original information to be stored is sent from the client systems to the server or the network-attached storage 100. This original information is written on the array's hard disks 104-110 by the storage array controller and then parity information is generated. The information created by the parity generator 112 will be stored in a remote networked location. Creating parity data and storing it in a remote location from the storage array controller and its local hard disks differentiates this embodiment of the invention from other prior art storage arrays. Instead of storing the parity information on an additional mass storage device or disk drive that is locally located with the storage array controller, the parity information is recorded on unused storage space that already exists on the network. Using this otherwise “vacant” space reduces the cost of the overall storage array.

The parity data is stored on a client system that includes a client mass storage device 114, 116. The mass storage device within the client system includes a distributed storage file 118, 120 that is configured to store the parity data. Further, the client system's mass storage devices include logic or a communications system that is able to communicate with the storage array controller and transmit or receive the parity data from the storage array controller.

The distributed data stored on the distributed storage system can be the common operating environment (COE) as described in relation to FIG. 2. This takes advantage of organizations with multiple personal computer systems to distribute parity data on each system for the COE image. If a new system is added to the network or a crashed system needs to be rebuilt, then the recovery logic on the client systems can be used in conjunction with the image in the storage array to create a new COE on the target client system.

Although FIG. 4 illustrates two client mass storage devices, it is also possible that many client mass storage devices will be used. For example, some networks may include a hundred, a thousand or even several thousand clients with distributed storage files that will be attached to the network 122. The parity data can alternatively be written to the client mass storage devices in a sequential manner either by filling up the distributed storage file of each client mass storage device first or by writing each parity block to a separate client mass storage device in a rotating pattern.

Each figure above also illustrates a local mass storage but this is not a required component of the system. The system can also operate with a centralized storage array controller that has no local mass storage and the client systems will store the distributed data.

An alternative embodiment of the present device can be a combination of FIGS. 1, 3 and 4 or the storage of distributed data on client systems interleaved with parity data as necessary. In a similar manner, redundant data can be stored on client mass storage devices and the interleaved parity data related to that data can be stored on the client systems' mass storage devices.

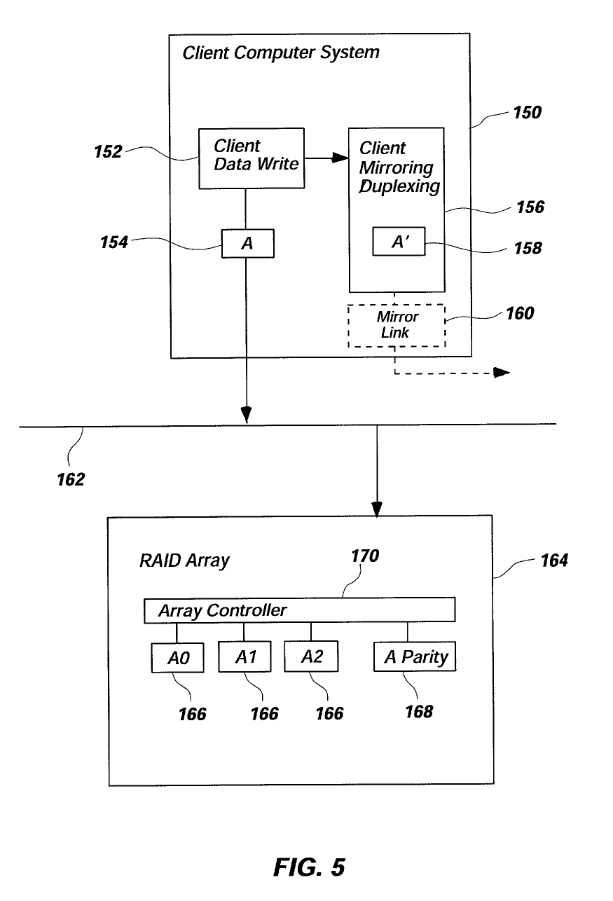

FIG. 5 illustrates a distributed storage system where client data that is written from a client system 150 is mirrored or duplexed on the client system from which the data originates or on other clients. As illustrated in FIG. 5, a client computer system 150 will contain a client redirector or similar client communication device 152 that can send data writes 154 to a network 162. As the data writes are sent to the network, a second copy of the data write is sent to the client mirroring/duplexing module 156 and the data write is duplicated on the client system. A distributed storage file is created in the client's mass storage device (e.g., hard drive) and then the data 158 is stored in that file.

The networked data write 154 travels across the network 162 and is transferred to a distributed storage array or the networked RAID array 164. Then the RAID array controller 170 can store the data in a striped manner 166. Parity information 168 for the data written to the array controller can be stored on a parity drive or it can be stored in the client system 150.

An advantage of this configuration is that if the RAID array or network server (with the RAID array controller) fails, then the client system 150 can enable access to its own local mirroring system. This gives the client access to data that it has written to a RAID array or a server without access to the network. Later when the network is restored, the client mirroring system can identify the client system data that has been modified in the distributed storage file and resynchronize that data with the RAID array or network server.

An additional optional element of this embodiment is a mirror link 160 on the client system that links the client system 150 to additional client systems (not shown). This link can serve several functions. The first function of the mirror link is to allow the client system to access mirrored data on other client systems when the network fails. This essentially provides a peer-to-peer client network for data that was stored on the RAID array. Of course, the data that is stored between the peers is not accessed as quickly as the central network storage system but this provides a replacement in the event of a network failure.

An additional function the mirror link can provide is balancing the storage between the client mirroring modules. Some clients write to the network more often than other clients do. This results in distributed storage files on certain client systems that are larger than the distributed storage files on other client systems. Accordingly, the mirror link can redistribute the data between the client mirroring modules as needed. One method of redistribution is to redistribute the oldest information first so that recent data is locally accessible in the event of a network failure.

An example of the system in FIG. 5 helps illustrate the functionality of this distributed mirroring system. Suppose a client system is running a graphics processing application and the user has created a graphic or graphic document that should be saved. When the user saves the document, the client system generates the client data write 154 and the graphic document is written to the RAID array or server 164. The mirrored copy of the graphic document 158 is also written to the mirroring component 156 and mirrored in the distributed storage file. In the event that the network RAID array is inaccessible or fails, then the copy of the graphic document that was last copied to the client mirroring module is made available to the user of the client system.

The access to the mirrored information can be configured to happen automatically when the client system (or storage array client software) determines that the RAID array is unavailable. Alternatively, the client system may have a software switch available to the user to turn on access to their local mirroring information.

This embodiment avoids at least two access failure problems, one of these problems is that network clients tend to hang or produce error messages when they cannot access designated network storage devices. In this case, the client system can automatically redirect itself to the local copies of the documents, and this avoids hanging on the client side. It also allows the client peer mirroring to replace a network failure so that the client systems are able to access network documents on other client systems when the network and its centralized resources are unavailable. This saves time and money for companies who use this type of system, because local users will have more reliable network information access.

Another advantage of this system is that a separate mirror server or a separate array to mirror the RAID array is not needed. The system uses distributed storage files that utilize unused space on the client system. Since this is unused space, it is cost effective for the distributed data storage to use the space until it is needed by the client system.

In some situations, the amount of space available to the distributed storage file may decrease significantly. Then the client mirroring module and the mirror link may redistribute data over to another client system. Redistribution may also be necessary if the client uses up the space on its local hard drive by filling it with local data and operating system information, etc. In this case, the client mirroring can either store just a little data, or remove the local distributed storage file and then notify the network administrator that this client system is nearly out of hard drive space. Based on the current price of mass storage and the trend toward increasing amounts of mass storage, a filled local hard drive is unlikely to happen. Even if the local disk is filled, replacing it may allow a system administrator to increase the amount of mass storage available on the entire storage system inexpensively.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A device for storing distributed data in a networked storage array, comprising:
a mass storage controller associated with a network;
a mass storage device that is controlled by the mass storage controller, wherein the mass storage device includes a portion of the distributed data; and
a plurality of client systems, having client mass storage, that each store a portion of the distributed data in a distributed storage file on the client mass storage, as directed by the mass storage controller, wherein the client mass storage is used primarily for the client system's data.

2. A device as in claim 1, wherein the client systems store striped data in the distributed storage file of the client mass storage, where the data is a mirror of distributed data stored on the mass storage device controlled by the mass storage controller.

3. A device as in claim 1, further comprising a network that is coupled between the client systems and the mass storage controller to transfer distributed data between the client systems and the mass storage controller.

4. A device as in claim 1, further comprising a common operating environment image stored on the mass storage device and distributed storage files of the client systems.

5. A device as in claim 4, further comprising image assembly and loading logic configured to assemble and install the common operating environment image, which is stored on the client mass storage and mass storage device, on a target client that calls for a new installation of the common operating environment image.

6. A device as in claim 1, wherein the mass storage controller is a hardware card mounted within a network server.

7. A device as in claim 1, wherein the mass storage device is a hard drive that is coupled to the mass storage controller.

8. A device as in claim 1, wherein the mass storage device stores parity data for the networked storage array.

9. A device as in claim 1, wherein the distributed storage file of the client mass storage, which contains the distributed data, is inaccessible to a user of the client system.

10. A device as in claim 9, wherein the distributed storage file in the client mass storage is hidden from a user.

11. A device as in claim 10, wherein the distributed storage file of the client mass storage is dynamically resizable.

12. A device for storing distributed data in a networked storage array, comprising:
a mass storage controller associated with a network;
a plurality of mass storage devices that are controlled by the mass storage controller, wherein each mass storage device includes a portion of the distributed data; and
a plurality of client systems that communicate with the mass storage controller, each having a client mass storage device, including a distributed storage file configured to store parity data.

13. A device in accordance with claim 12, wherein the distributed storage file on the client systems each include a portion of the parity data that is inversely proportional in size to the number of client mass storage devices available.

14. A device in accordance with claim 12, wherein the client mass storage device is a hard drive and the parity data is stored on a portion of the client's hard drive that is unused by the client system's primary data.

15. A device in accordance with claim 14, wherein the distributed storage file is hidden from a user who is using the client system.

16. A device as in claim 12, further comprising a common operating environment image stored on the mass storage devices and the client systems.

17. A device as in claim 16, further comprising install logic configured to assemble and install the common operating environment image on a target client that calls for a new installation of the common operating environment image.

18. A device for storing distributed data in a networked storage array, comprising:
a mass storage controller associated with a network;
a plurality of mass storage devices that are controlled by the mass storage controller, wherein the mass storage devices each include a portion of the distributed data; and
a plurality of client systems in communication with the mass storage controller, each having at least one client mass storage with a distributed storage file, wherein distributed data that is written to the mass storage devices through the mass storage controller is mirrored to the distributed storage file on the client mass storage.

19. A device as in claim 18, wherein the distributed storage file used to store the mirrored client data on the client mass storage is inaccessible to a user of the client system.

20. A device as in claim 18, wherein the client mass storage used by the respective client systems are selected from the group of mass storage devices consisting of hard drives, flash memory, and rewritable optical drives.

21. A device as in claim 18, wherein the client mass storage can be accessed by the client system when the mass storage controller is unavailable through the network.

22. A device as in claim 18, further comprising a mirroring module and a mirror link, where the mirror link allows the mirroring module to access the mirroring module of other client systems when the mass storage controller is unavailable through the network.

23. A method for installing a common operating environment from a distributed storage array on a network, the method comprising the steps of:
dividing a common operating environment image into a plurality of image segments, wherein the common operating environment image includes an operating system and applications;
allocating a distributed storage file in a mass storage on each of a plurality of client systems where image segments can reside;
storing the image segments in the distributed storage files of the client systems as directed by a storage array controller; and
adding a target client to the network that calls for a common operating environment; and
installing the common operating environment image onto the target client from the image segments in the distributed storage files.

24. A method as in claim 23, further comprising the step of assembling at least a part of the common operating environment image from the image segments in the distributed storage files in order to facilitate the installation of the common operating environment.

25. A device for storing distributed data in a networked storage array, comprising:
means for controlling the storage of distributed data on a network;
means for mass storage that is controlled by the controller means, wherein the means for mass storage stores a portion of the distributed data; and
a plurality of client systems, each having means for storing mass client data, which each store a portion of the distributed data in a distributed storage file on the means for storing mass client data, as directed by the means for controlling the storage, wherein means for storing mass client data is used primarily for the client system's data.
